(19) United States
(12) Patent Application Publication
(10) Pub. No.: US 2011/0087495 A1
(43) Pub. Date: Apr. 14, 2011

(54) SUSPICIOUS ENTITY INVESTIGATION AND RELATED MONITORING IN A BUSINESS ENTERPRISE ENVIRONMENT

(75) Inventors: John O'Neill, Bel Air, MD (US); Denise Truman, Belmont, NC (US); William Hardy, Charlotte, NC (US); Xu He, Charlotte, NC (US); Frederick Stone, Matthews, NC (US); Tammy Hurst, Plano, TX (US)

(73) Assignee: Bank of America Corporation, Charlotte, NC (US)

(21) Appl. No.: 12/872,747

(22) Filed: Aug. 31, 2010

Related U.S. Application Data
(60) Provisional application No. 61/251,501, filed on Oct. 14, 2009.

(51) Int. Cl. G06Q 99/00

(52) U.S. Cl. 705/1.1

(57) ABSTRACT

Systems, methods, and computer program products are provided for monitoring of financial institution business activity for the purpose of identifying suspicious activities. The embodiments herein described rely on monitoring business activities from many data repositories, some of which are exclusive to financial institution. By monitoring financial business activity for the purpose of identifying suspicious activity or behaviors, bank fraud or other criminal/wrongful activities can be mitigated or otherwise avoided. In addition, the identification of suspicious activities serves to identify the individual(s) associated with the suspicious activities and/or other information related to the individual(s), such as physical location, electronic location, telephone number and the like.

### CLAIM OF PRIORITY UNDER 35 U.S.C. §119

The present Application for Patent claims priority to Provisional Application No. 61/251,501 entitled “Suspicious Activity Monitoring in a Financial Institution Enterprise” filed Oct. 14, 2009, and assigned to the assignee hereof and hereby expressly incorporated by reference herein.

### FIELD

In general, embodiments herein disclosed relate to systems, methods, and computer program products for suspicious entity investigation and monitoring and, more specifically, systems, methods and computer program products that investigating a suspicious entity associated with a business, for example a customer and determine related suspicious entities based on identification of business-related identifying characteristics of the suspicious entity.

### BACKGROUND

Bank fraud is a term used to describe the use of fraudulent means to obtain money, assets, or other property owned or held by a financial institution. While the specific elements of a particular banking fraud law vary between jurisdictions, the term bank fraud applies to actions that employ a scheme or artifice, as opposed to bank robbery or theft. For this reason, bank fraud is sometimes considered a white collar crime. Examples of bank fraud include, but are not limited to, check kiting, money-laundering, payment/credit card fraud, and ancillary frauds such identification theft, phishing and Internet fraud and the like.

In addition to bank fraud other financial institution business activity or other non-financial institution business activity in general may rise to the level of suspicious activity that may be associated with other criminal acts or activities. In this regard, the suspicious activity, if identified, may be instrumental in identifying criminals, the location of criminals or other information pertinent to criminal activity, such as telephone numbers, IP addresses and the like. In the financial institution realm these suspicious activities may include, but are not limited to, bank transactions, such as deposits, withdrawals, loan transactions and the like; credit card transactions; online banking activity such as compromised online banking IDs and the like; electronic commerce activity; call center activity and the like. Additionally suspicious activity may be determined from data related to computer security violators (i.e., hackers), fraudulent telephone calls, and entities associated with divisive computer programs (e.g., viruses, trojans, malware and the like) and the like.

In many instances financial institutions or businesses in general have difficulty identifying ongoing fraud or other nefarious activities until the fraud or crime has escalated to a level that has serious negative financial impact. Therefore, a need exists to monitor and otherwise identify suspicious activities related bank fraud and other criminal or wrongful activities. By monitoring financial business activity for the purpose of identifying suspicious activity or behaviors, bank fraud or other criminal/wrongful activities can be mitigated or otherwise avoided.

In addition, fraud or other suspicious activities are typically not undertaken by a lone perpetrator, but rather such activities are typically carried out by a network of individuals. Therefore, a need exists to identify individuals associated with a previously identified suspicious individual and to assess the relationship or association between the individuals to determine if the related individual is indeed associated with a suspicious activity.

### SUMMARY

The following presents a brief summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Thus, systems, methods and computer program products are defined that provide for suspicious entity investigation for the purpose of determining, within a business enterprise, such as a financial institution or the like, entities/individuals associated with a suspicious entity/individual. The “link” or connection between the related entities/individuals and the suspicious entity/individual is such that the related entities/individuals may be considered suspicious entities/individuals that warrant further investigation on behalf of a law enforcement agency or the like.

A method for investigating a suspicious entity associated with a business, such as a financial institution or the like defines first embodiments of the invention. The method includes receiving data associated with a suspicious individual and verifying, via a computing device processor, that the suspicious entity is associated with the business based on the data. The method further includes identifying, via a computing device processor, a plurality of business-related identifying characteristics associated with the suspicious individual. In addition, the method includes determining, via a computing device processor, one or more related entities associated with the suspicious entity based on at least one link between each of the related entities and the identifying characteristics associated with the suspicious entity.

In specific embodiments of the method, receiving data further includes receiving one or more of a name, a physical address, a telephone number, an electronic mail address, or an Internet Protocol address. In further embodiments of the method, receiving data associated with a suspicious entity further includes monitoring, via a computing device processor, business activity based on predetermined suspicious activity criteria to determine the data. In further related embodiments of the method, the data may be received from an internal source, such as through suspicious activity monitoring or an external source, such as a law enforcement agency or the like.

In other specific embodiments of the method, verifying further includes verifying, via the computing device processor, that the suspicious entity is a customer of the business, such as a financial institution customer or the like, based on a match between the data received and a customer profile.

In further specific embodiments of the method, identifying further includes identifying, via a computing device processor, the plurality of business-related identifying characteristics, wherein the identifying characteristics include a physical address stored in customer profile associated with the suspicious individual. In such embodiments of the method, determining further includes determining, via a computing device processor, the one or more related entities associated with the suspicious entity based on at least one link, wherein the links include the related entities being associated with the physical address of the suspicious individual.

In other specific embodiments of the method identifying further includes identifying, via a computing device processor, the plurality of business-related identifying characteristics, wherein the identifying characteristics include one or more accounts associated with the suspicious entity held at the business. In such embodiments, determining further comprises determining, via a computing device processor, the one or more related entities associated with the suspicious entity based on at least one link, wherein the links include the related entities being associated with at least one of the accounts associated with the suspicious individual (e.g., a joint account or the like).

In still further specific embodiments of the method, identifying further includes identifying, via a computing device processor, the plurality of business-related identifying characteristics including wherein business encounter-related identifying characteristics. In such embodiments, identifying may further include identifying, via a computing device processor, the plurality of business encounter-related identifying characteristics, wherein the business encounter-related identifying characteristics are based on the business encounter requiring user authentication.

In such related embodiments of the method, identifying may further include identifying, via a computing device processor, the plurality of business encounter-related identifying characteristics, wherein the identifying characteristics include one or more telephone numbers from which the suspicious entity contacted a business call center. In such embodiments, determining may further include determining, via a computing device processor, the one or more related entities associated with the suspicious entity based on at least one link, wherein the links include the related entities having contacted the business call center from one of the telephone numbers.

In further related embodiments of the method, identifying may further include identifying, via a computing device processor, the plurality of business encounter-related identifying characteristics, wherein the identifying characteristics include one or more Internet Protocol (IP) addresses associated with suspicious entity and used for computer network communication between the suspicious entity and the business. In such embodiments, determining may further include determining, via a computing device processor, the one or more related entities associated with the suspicious entity based on at least one link, wherein the links include the related entities having used one of the IP addresses for computer network communication with the business.

In still further related embodiments of the method, identifying further includes identifying the plurality of business encounter-related identifying characteristics, wherein the identifying characteristics include one or more identifying text files, such as a cookie or the like, associated with a computing device that was used for computer network communication between the suspicious entity and the business. In such embodiments, determining may further include determining, via a computing device processor, the one or more related entities associated with the suspicious entity based on at least one link, wherein the links include the related entities being associated with one of the identifying text files and having used the computing device for computer network communication with the business.

An apparatus for investigating a suspicious entity associated with a business provides for second embodiments of the invention. The apparatus includes a computing platform including a memory and processor in communication with the memory. The apparatus further includes a suspicious entity identifying characteristic routine stored in the memory, executable by the processor and configured to identify a plurality of business-related identifying characteristics associated with the suspicious individual. In addition, the apparatus includes a related suspicious entity determining routine stored in the memory, executable by the processor and configured to determine one or more related entities associated with the suspicious entity based on at least one link between each of the related entities and the identifying characteristics associated with the suspicious individual.

In specific embodiments the apparatus further includes, a suspicious entity verification routine stored in the memory, executable by the processor and configured to receive data associated with a suspicious entity and verify that the suspicious entity is associated with the business based on the data. In such embodiments, the suspicious entity verification routine may be further configured to receive one or more of a name, a physical address, a telephone number, an electronic mail address, or an Internet Protocol address. In further such embodiments, the suspicious entity verification routine is further configured to verify that the suspicious entity is a customer of the business, such as a financial institution customer or the like, based on a match between the data and a customer profile.

In other specific embodiments of the apparatus, the suspicious entity identifying characteristic routine is further configured to identify the plurality of business-related identifying characteristics, wherein the identifying characteristics include a physical address stored in customer profile associated with the suspicious individual. In such embodiments, the related suspicious entity determining routine may be further configured to determine the one or more related entities associated with the suspicious entity based on at least one link, wherein the links include the related entities being associated with the physical address of the suspicious individual.

In still other specific embodiments of the apparatus, the suspicious entity identifying characteristic routine is further configured to identify the plurality of business-related identifying characteristics, wherein the identifying characteristics include one or more accounts associated with the suspicious entity held at the business. In such embodiments of the apparatus, the related suspicious entity determining routine may be further configured to determine the one or more related entities associated with the suspicious entity based on at least one link, wherein the links include the related entities being associated with at least one of the accounts associated with the suspicious individual.

Moreover, in further specific embodiments of the apparatus, the suspicious entity identifying characteristic routine is further configured to identify the plurality of business-related identifying characteristics, wherein the identifying characteristics include business encounter-related identifying characteristics. In such embodiments of the apparatus, the suspicious entity identifying characteristic routine may be further configured to identify the plurality of business encounter-related identifying characteristics, wherein the business encounter-related identifying characteristics are based on the business encounter requiring user authentication.

In related additional specific embodiments of the apparatus, the suspicious entity identifying characteristic routine is further configured to identify the plurality of business encounter-related identifying characteristics, wherein the identifying characteristics include one or more telephone numbers from which the suspicious entity contacted a business call center. In such embodiments, the related suspicious entity determining routine may be further configured to determine the one or more related entities associated with the suspicious entity based on at least one link, wherein the links include the related entities having contacted the business call center from one of the telephone numbers.

In further related specific embodiments, the suspicious entity identifying characteristic routine is further configured to identify the plurality of business encounter-related identifying characteristics, wherein the identifying characteristics include one or more Internet Protocol (IP) addresses associated with suspicious entity and used for computer network communication between the suspicious entity and the business. In such embodiments, the related suspicious entity determining routine may be further configured to determine the one or more related entities associated with the suspicious entity based on at least one link, wherein the links include the related entities having used one of the IP addresses for computer network communication with the business.

In other related specific embodiments of the apparatus, the suspicious entity identifying characteristic routine is further configured to identify the plurality of business encounter-related identifying characteristics, wherein the identifying characteristics include one or more identifying text files associated with a computing device that was used for computer network communication between the suspicious entity and the business. In such embodiments, the related suspicious entity determining routine may be further configured to determine the one or more related entities associated with the suspicious entity based on at least one link, wherein the links include the related entities being associated with one of the identifying text files and having used the computing device for computer network communication with the business.

A computer program product including a computer-readable medium defines third embodiments of the invention. The computer-readable medium includes a first set of codes for causing a computer to receive data associated with a suspicious individual. In addition, the computer-readable medium includes a second set of codes for causing a computer to verify that the suspicious entity is associated with the business based on the data. Additionally, the computer-readable medium includes a third set of codes for causing a computer to identify a plurality of business-related identifying characteristics associated with the suspicious individual. Moreover, the computer-readable medium includes a fourth set of codes for causing a computer to determine one or more related entities associated with the suspicious entity based on at least one link between each of the related entities and the identifying characteristics associated with the suspicious individual.

Thus, systems, methods and computer program products are defined that provide for investigating suspicious entities associated with a business, such as customer and, more specifically financial institution customer. The investigating includes verifying that the suspicious entity is associated with the business and identifying business-related identifying characteristics associated with the suspicious entity. Further, the investigation determines one or more related suspicious entities based on a link between each of the related entities and the identifying characteristics associated with the suspicious entity. Once the related suspicious entities are determined, they may form the basis for a suspicious activity report (SAP) or a government agency, such as a law enforcement agency or the like, may be notified of the suspicious entities.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus configured for suspicious entity investigation, in accordance with embodiments of the present invention;

FIG. 2 is a detailed block diagram of an apparatus configured for suspicious entity investigation, in accordance with embodiments of the present invention;

FIG. 3 is a flow diagram of a method for suspicious entity investigation, in accordance with embodiments of the present invention;

FIG. 4 is a schematic diagram highlighting an example of suspicious entity investigation, in accordance with embodiments of the present invention;

FIG. 5 is another schematic diagram highlighting an example of suspicious entity investigation, in accordance with embodiments of the present invention;

FIG. 6 is a block diagram of a system of suspicious activity monitoring in a financial institution enterprise, in accordance with an embodiment of the present invention;

FIG. 7 is a more detailed block diagram of a system of suspicious activity monitoring in a financial institution enterprise, highlighting alternative embodiments of the present invention;

FIG. 8 is a flow diagram of a method for method for monitoring suspicious activity in a financial institution enterprise environment, in accordance with present embodiments;

FIG. 9 is another flow diagram of a method for monitoring suspicious activity in a financial institution enterprise environment, in accordance with present embodiments;

FIG. 10 is another flow diagram of an alternative method for method for monitoring suspicious activity in a financial institution enterprise environment, in accordance with present embodiments; and

FIG. 11 is yet another flow diagram of another alternative method for method for monitoring suspicious activity in a financial institution enterprise environment, in accordance with present embodiments.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Present embodiments provide for systems, methods, computer program products and the like provide for business environment suspicious entity investigation for the purpose of determining other entities related to the suspicious entity that may also be suspicious entities. In specific embodiments of the invention, business-related identifying characteristics are identified for a suspicious entity and, subsequently, related suspicious entities are determined based on a link between the related suspicious entities and one of the identifying characteristics.

Additional embodiments of the invention provide for monitoring of financial institution business activity for the purpose of identifying suspicious activities. The embodiments herein described rely on monitoring business activities from many data repositories, some of which are exclusive to financial institution. In specific embodiments of the invention, identification of a suspicious activity may automatically trigger further monitoring in attempt to uncover further suspicious activities or events. In other embodiments, predictive modeling may used to identify predetermined suspicious activity patterns or predetermined combinations of suspicious activity that may otherwise go unnoticed. Thus, the embodiments herein described provide for heightened identification of suspicious activities.

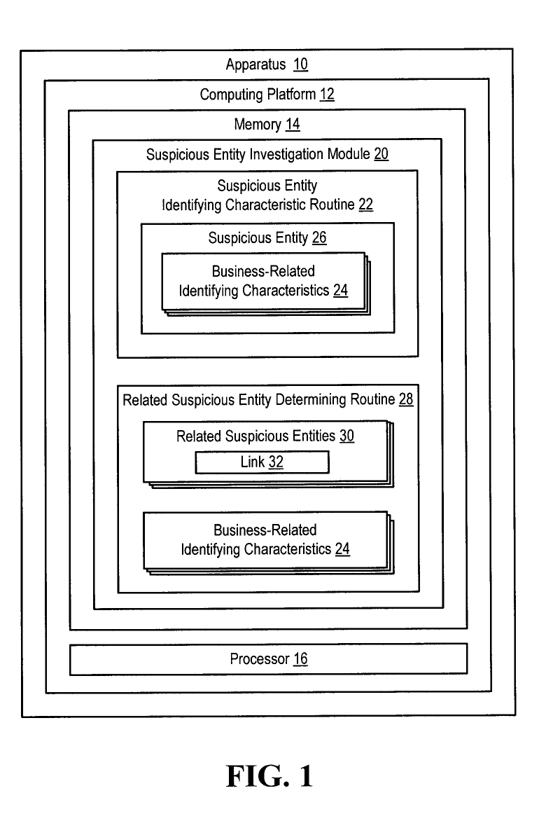

Referring to FIG. 1 a block diagram is illustrated of an apparatus 10 configured to provide suspicious entity investigation, in accordance with embodiments of the present invention. An “entity” as defined herein may be an individual, a group of individuals or an innate object, such as a physical location, a business account, a computer network address or the like. Further the suspicious entity investigation herein described pertains to business investigations if suspicious entities and, in specific embodiments, financial institution investigations of suspicious entities. Financial institutions are in a unique position to analyze suspicious entities and activities due in part to their access to a myriad of information, including, but not limited to, account information transaction information and the like.

The apparatus includes a computing platform 12 having a memory 14 and at least one processor 16 in communication with the memory 14. The memory 14 of apparatus 10 stores suspicious entity investigation module 20 that is executable by the processor 16 and configured to investigate a suspicious entity associated with the business, such as a customer or the like and determine related suspicious entities based on link between the related suspicious entities and identifying characteristics associated with the suspicious entity.

Thus, suspicious entity investigation module 20 includes suspicious entity identifying characteristic routine 22 that is configured to identify a plurality of business-related identifying characteristics 24 associated with the suspicious entity 26. For example, in the instance in which the suspicious entity is a customer, the identifying characteristics may include personal data, such as social security number, customer identification number, physical address, customer accounts and the like.

In addition, the business-related identifying characteristics 24 may further be defined as business-transaction related identifying characteristics. The term “transaction” as used herein includes an exchange, such as an exchange of funds or the like and any other inquiry made with the business. In the financial institution realm, such business-transaction related identifying characteristics may pertain to various different transaction channels, such as financial institution/banking center, telephone call center, online/e-commerce banking, automated teller machine (ATM) and the like. Thus, the business-transaction identifying characteristics 24 may include, but are not limited to, telephone numbers associated with call center transaction or inquiries. Internet Protocol (IP) addresses associated with online or computer network communication with the business, an identifying text file, i.e., a sentinel cookie communicated from the computing device during online or computer network communication with the business or the like.

The suspicious entity identifying characteristic routine 22 may identify identifying characteristics 24 by searching and/or monitoring any known or future known database, such as, but not limited to, personal databases; transaction databases, including call center databases, credit card databases, online databases, e-commerce databases; and suspicious activity related databases, including historical fraud databases, compromised account databases, fraudulent telephone call databases, counter fraud databases and the like.

The suspicious entity investigation module additionally includes related suspicious entity determining routine 28 that is configured to determine one or more related suspicious entities that are associated with the suspicious entity 26 based on at least one link 32 between each of the related suspicious entities 30 and the identifying characteristics 24 associated with the suspicious entity 26. For example, the link 32 may be that the related suspicious entity 30 has the same physical address as the suspicious entity 26. In another example, the link 32 may be that the related suspicious entity has used the same telephone number to contact the business, such as a call center, that has been used by the suspicious entity to contact the business.

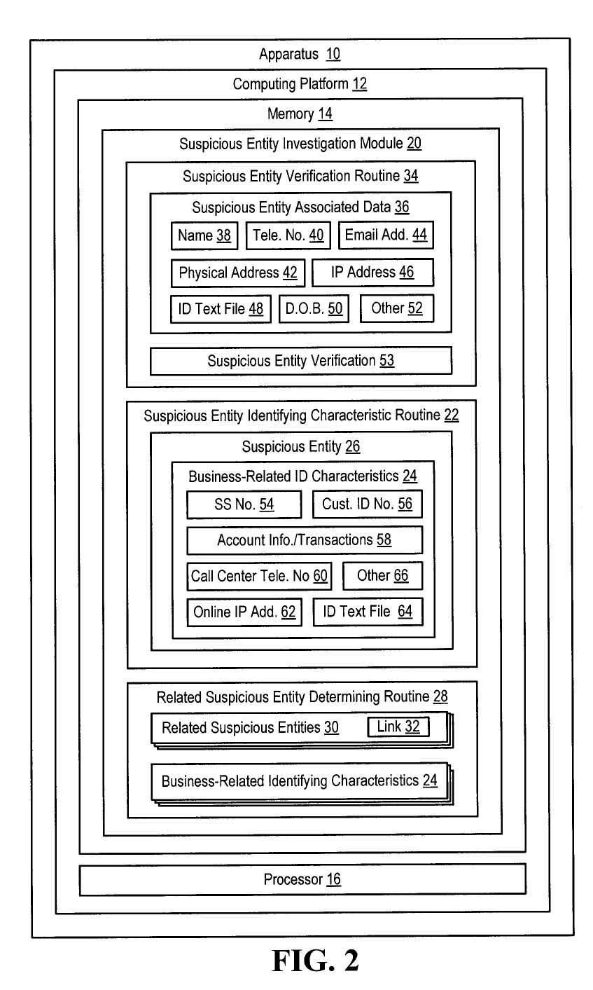

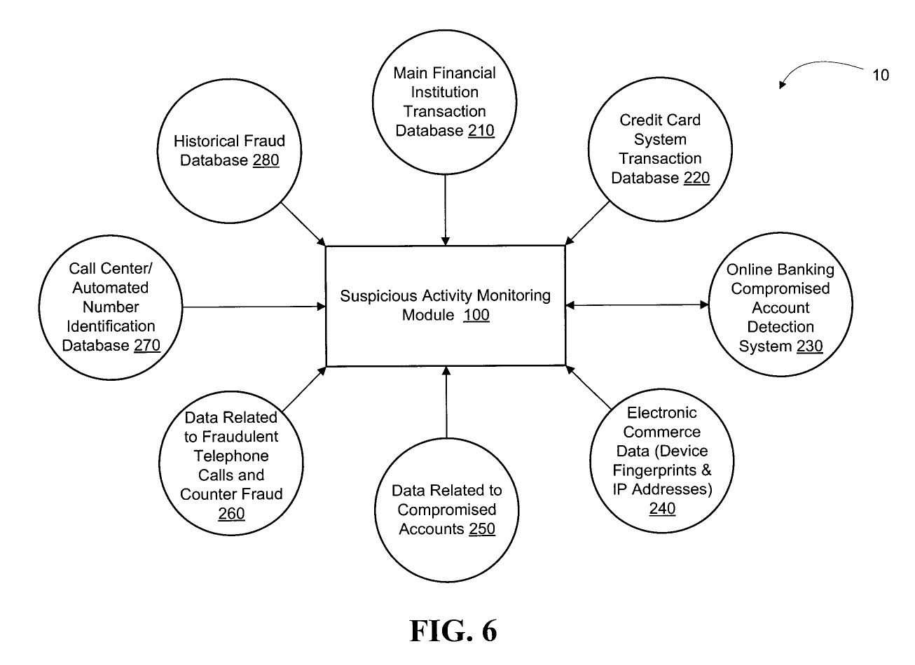

Turning the reader's attention to FIG. 2 a more detailed apparatus 10 is shown that highlights optional embodiments of the suspicious entity investigation module 20, in accordance with embodiments of the present invention. The suspicious entity investigation module 20 may optionally include suspicious entity verification routine 34 that is configured to verify that a suspicious entity is associated with the business based on data received. The suspicious entity associated data 36 may be received from an internal source within the business, such as suspicious activity monitoring as described infra., in relation to FIG. 6-11, or the suspicious entity associated data 36 may be received from an external source, such as a government agency performing an investigation or the like.

The suspicious entity associated data 36 may include any data that may verify the suspicious entity's association with the business, such as any data that may verify that the suspicious entity is a customer of the business. Thus, suspicious entity associated data 36 may include, but is not limited to, one or more of a name 38, a telephone number 40, a physical address 40, an email address 44, an IP address, an identifying text file (e.g., a sentinel cookie) 48, a date of birth 50 or any other data 52. The data 36 that is received is used as an input for the suspicious entity verification routine 36, which verifies that the suspicious entity data 36is associated with the business, such as a customer of the business or the like, the verification results in suspicious entity verification 53.

As previously noted, suspicious entity investigation module 20 includes suspicious entity identifying characteristic routine 22 that is configured to automatically identify business-related identifying characteristics associated with a suspicious entity. The routine 22 will search and/or monitor various databases for identifying characteristics associated with the suspicious entity. As noted these data bases may include, but are not limited to, personal databases; transaction databases, such as account credit card databases, call center databases, e-commerce databases and online databases; suspicious activity databases, such as historical fraud databases, compromised account databases; counter party databases and the like.

The business-related identifying characteristics may include any data that may provide a link between the suspicious entity and other entities. Thus, business-related identifying characteristics may include, but is not limited to, a social security number 54; a customer identification number 56; account information and related transaction information 58; call center telephone numbers 60; IP addresses used for online account or e-commerce access 62; identifying text file (e.g., sentinel cookie) sent from computer device used for online network session or e-commerce network session or other identifying characteristic 66, such as personal data.

The suspicious entity investigation module 20 additionally includes previously noted related suspicious entity determining routine 28 that is configured to automatically determine one or more related entities 30 based on a link 32 between the related entities and the identifying characteristics 24 of the of the suspicious entity 26. The link 32 will depend on the nature of the identifying characteristic 24. For example, if the identifying characteristic 24 is the physical address of the suspicious entity 26, the link 32 may be the related entity 30 has the same physical address as the suspicious entity 26 or has otherwise used the same physical address for an account with the business or in corresponding with the business. In another example, if the identifying characteristic 24 is a telephone number 60 used by the suspicious entity 26 to contact the business, such as call center transactions or the like, the link 32 may be the related entity 30 having used the same telephone number to contact the business; such as call center transactions or the like. In a further example, if the identifying characteristic 24 is an IP address 62 assigned or otherwise associated with the suspicious entity 26, the link 32 may the related entity 30 having communicated with the business via the IP address or being listed on a communication (such as, an email or the like) sent from the IP address. In a still further example, if the identifying characteristic 24 is an identifying text file 64, such as a sentinel cookie or the like, communicated from the computing device by the suspicious entity during an online business session or e-commerce transaction, the link 32 may a related entity 30 having communicated with the business from the same computing device (and thus sent the same identifying text file 64) as the suspicious entity 26.

Once the related entities 30 have been identified the related entities may be presented to the user of the suspicious activity module 20. In one embodiment, the related entities may be presented in a ranked format in which related entities ranked first are the most related entities based on the number of related identifying characteristics, and/or the number of occurrences of related identifying characteristics and/or the importance designated to the identifying characteristics. Ranking the related entities provides the user with information as to which related entities may require further suspicious activity searching and monitoring. As previously noted, once the related entities 30 have been determined, the related entities 30 the activities/transactions of the related entities 30 may be searched and/or monitored to determine suspicious activities and, in particular, suspicious activities that may further relate the entity to the original suspicious entity. For example, suspicious purchases, such as firearms, from the same vendor/retailer as the original suspicious entity, similar wire transfers as the original suspicious entity and the like.

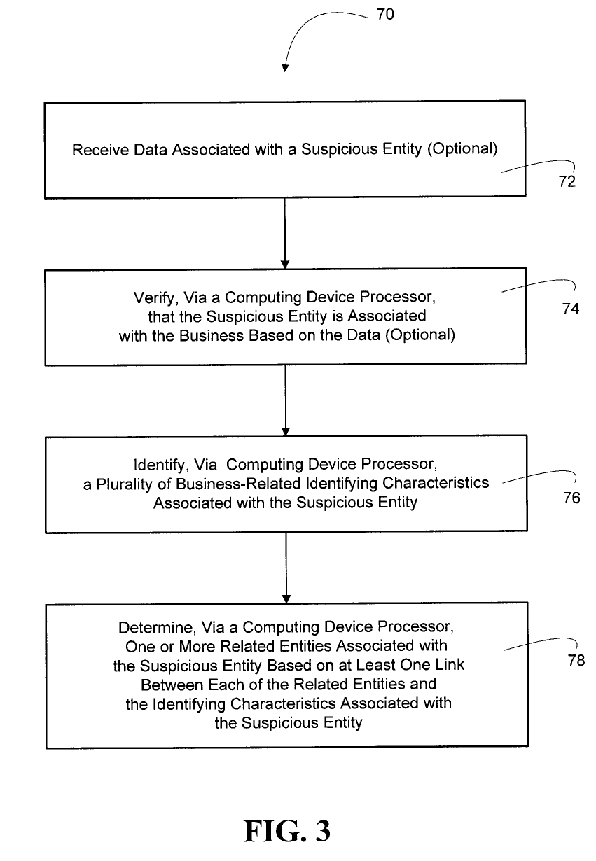

Referring to FIG. 3 a flow diagram is presented of a method 70 for suspicious entity investigation, in accordance with embodiments of the present invention. At optional Event 72, data associated with a suspicious entity is received. As previously noted the data may be received from an internal source, based on suspicious activity monitoring or the like, or the data may be provided from an external source, such as a government agency or the like. The data may include, but is not limited to, a name, a physical address, a telephone number, an email address, an IP address, an identifying text file, a date of birth, a social security number or the like.

At optional Event 74, verification occurs to verify that the suspicious entity is associated with the business based on the data received. The verification may include searching databases, such as personal databases account databases or the like to verify that the suspicious entity is or was a customer of the business or otherwise had contact with the business (e.g., inquired about becoming a customer, used the business for an ancillary purpose or the like).

At Event 76, a plurality of business-related identifying characteristics are identified for the suspicious entity based on the suspicious entities contacts with the business. The identifying characteristics may be identified by searching and/or monitoring various databases including, but not limited to, personal databases, transactions databases, fraud databases and the like. The identifying characteristics may include, but are not limited to, a social security number, a physical location, a business/customer identification number, account information including transaction data, telephone numbers from which the suspicious entity contacted the business, IP addresses assigned to or associated with the suspicious entity, identifying text files associated with computer devices used by the suspicious entity to communicate electronically with the business and the like.

At Event 78, one or more related entities are determined based on at least one link between each of the related entities and the business-related identifying characteristics of the suspicious entity. For example, if the identifying characteristic is the physical address of the suspicious entity, the link may be the related entity has the same physical address as the suspicious entity or has otherwise used the same physical address for an account with the business or in corresponding with the business. In another example, if the identifying characteristic is a telephone number used by the suspicious entity to contact the business, such as call center transactions or the like, the link may be the related entity having used the same telephone number to contact the business; such as call center transactions or the like. In a further example, if the identifying characteristic is an IP address assigned or otherwise associated with the suspicious entity, the link may the related entity having communicated with the business via the IP address or being listed on a communication (such as, an email or the like) sent from the IP address. In a still further example, if the identifying characteristic is an identifying text file, such as a sentinel cookie or the like, communicated from the computing device by the suspicious entity during an online business session or e-commerce transaction, the link may a related entity having communicated with the business from the same computing device as the suspicious entity.

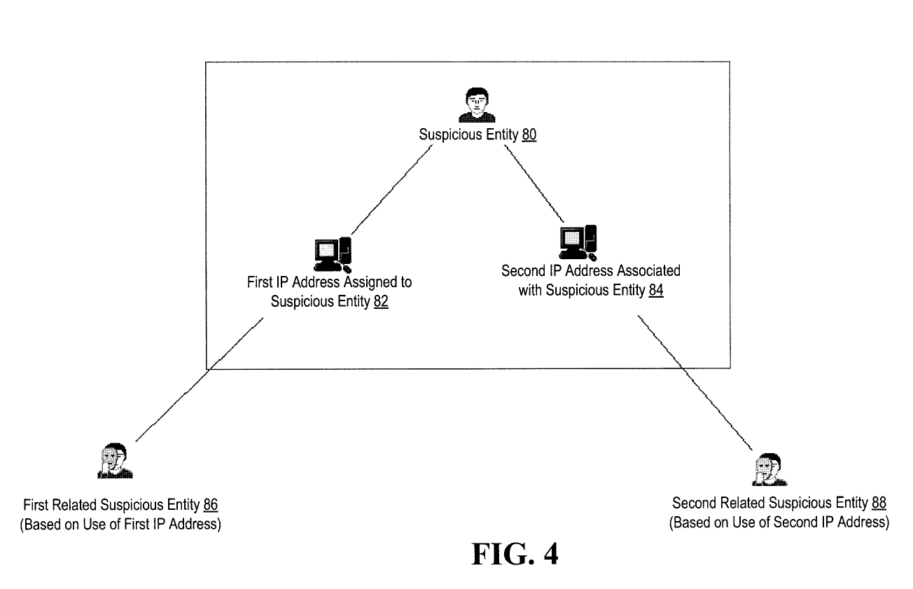

FIG. 4 provides a schematic diagram of an example of suspicious entity investigation, in accordance with embodiments of the invention. In the illustrated example, the suspicious entity 80 has identifying characteristics in the form of two IP addresses; the first IP address 82 is assigned/registered to the suspicious entity 80. The second IP address 84 is assigned/registered or otherwise associated with suspicious entity 80. A related entity determination determined existence of first related entity 86 based on the first related entity having network session logons to the business, such as an online banking session, from the same IP address as the suspected entity, first IP address 82. Further, the related entity determination determined existence of second related entity 88 based on the second related entity having communicated an email to the business or another organization from the same IP address as the suspected entity, second IP address 84.

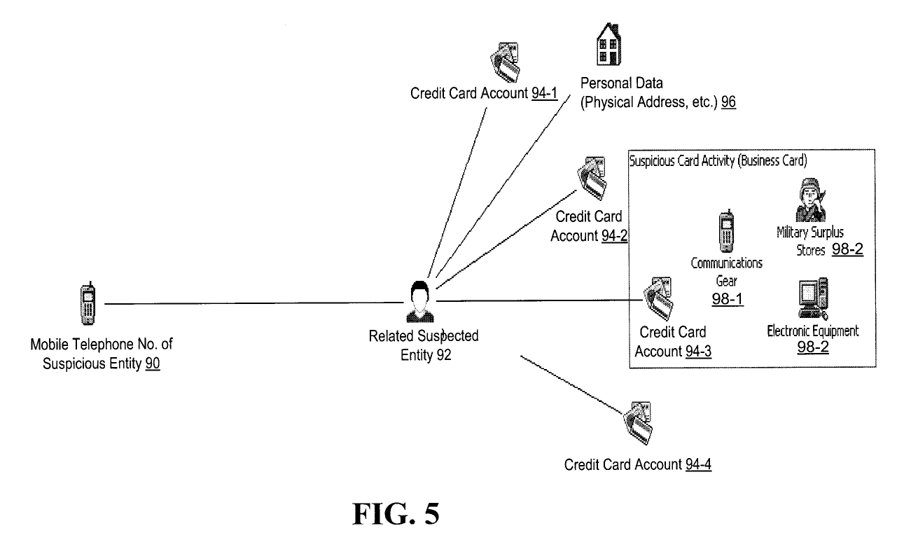

FIG. 5 provides a schematic diagram of another example of suspicious entity investigation, in accordance with other embodiments of the present invention. In the illustrated example, an identifying characteristic of a suspicious entity has been identified in the form of a telephone number 90. In this example, the telephone number is a mobile telephone number which has been used by the suspicious entity to conduct call center transactions. Further, related suspicious entity 92 has been determined to exist based on a link between the related suspicious entity and the identifying characteristic of the original suspicious entity; specifically, the related suspicious entity 92 has also contacted the business using the same mobile telephone number 90 associated with the original suspicious entity.

Further investigation of the suspicious entity, in the form of suspicious activity searching and/or monitoring, has uncovered that related suspicious entity 92 is associated with four credit card accounts 94-1, 94-2, 94-3, 9404 with the business and has a business profile that includes personal data 96, such as a physical address, telephone number(s) and the like. In addition, specific suspicious activity has been identified in the form of purchases made via one of the credit card accounts 96-3. Specifically, related suspicious entity 92 has conducted transactions using credit card account 96-3 to purchase communication gear 98-1, electronic equipment 98-2, as well as multiple purchases at military surplus stores 98-3. Based on the information uncovered in the suspicious entity investigation and the suspicious activity monitoring of the related suspicious entity, a suspicious activity report (SAR) may be generated by the business and communicated to the applicable government authority.

Referring to FIG. 6 a block diagram is depicted of a system 10 for suspicious activity monitoring in financial institution enterprise, in accordance with an embodiment of the invention. Financial institutions provide access to a myriad of data that may be otherwise unavailable to other entities for the purpose of conducting monitoring and/or investigation of suspicious activity. The system 10 includes a suspicious activity monitoring module 100 that is configured to monitor or otherwise provide suspicious activity analysis on the business activity data or other data received from various data repositories or databases associated with the financial institution.

The data repositories may include, but are not limited to, main financial institution transaction database 210 that may include account transactions, such as savings/checking deposits and withdrawals; mortgage loan transactions; other loan transactions, such home equity loans and the like. The data repositories also include credit card system transaction database 220 that includes data related to credit card purchases and payments, including date/time of purchases and items purchased. Additionally, the data repositories include online banking compromised account detection system 230 that tracks erroneous attempts at accessing an online account, simultaneous duplicate requests to access an online account and any other means of compromising the online banking account.

Moreover, the data repositories that feed information to the suspicious activity monitoring module 100 may include electronic commerce (i.e., e-commerce) data 240, such as tracking data related to a device fingerprint and/or Internet Protocol (IP) addresses. Device fingerprint tracking may provide for tracking one or more of various characteristics related to a computing device. Additionally, the data repositories may include other data related to compromised account data 250, which includes data related to computer security violators (i.e., hackers) or the like. Additionally, data 260 may include data related to fraudulent telephone calls and/or a counter fraud intelligence platform that provides information related to viruses, trojans, malware and the like that targets financial institution customers.

Additionally, the data repositories that communicated information to the suspicious activity monitoring module 100 may include call center/Automated Number Identification (ANI) data that may include data from a plurality of call centers. Further, historical fraud database 280 may communicate lists of all identified financial institution frauds, including name, address, telephone number, IP address of all perpetrators.

The suspicious activity monitoring module 100 may be based on an SQL server or the like and provides for a database to receive real-time or scheduled feeds from the plurality of data repositories. The suspicious activity monitoring module 100 provides for correlation and/or format of the data received from the data repositories, thereby providing an analyst/user access to the data for the purpose of monitoring suspicious activity. In this regard, the suspicious activity monitoring module 100 will receive, either by manual analyst input or through an automated feed, external data potentially associated with a suspicious activity. The external data, which may be obtained from a public such as declassified documents, media outlets or the like, may include but is not limited, a name of an individual or group of individuals, a telephone number, a physical address, an electronic address, such as an email address or IP address or the like. Based on the external data, the suspicious activity monitoring module 100 may search or continually monitor for instances of the external data or data related to the external data as a means of identifying suspicious activity.

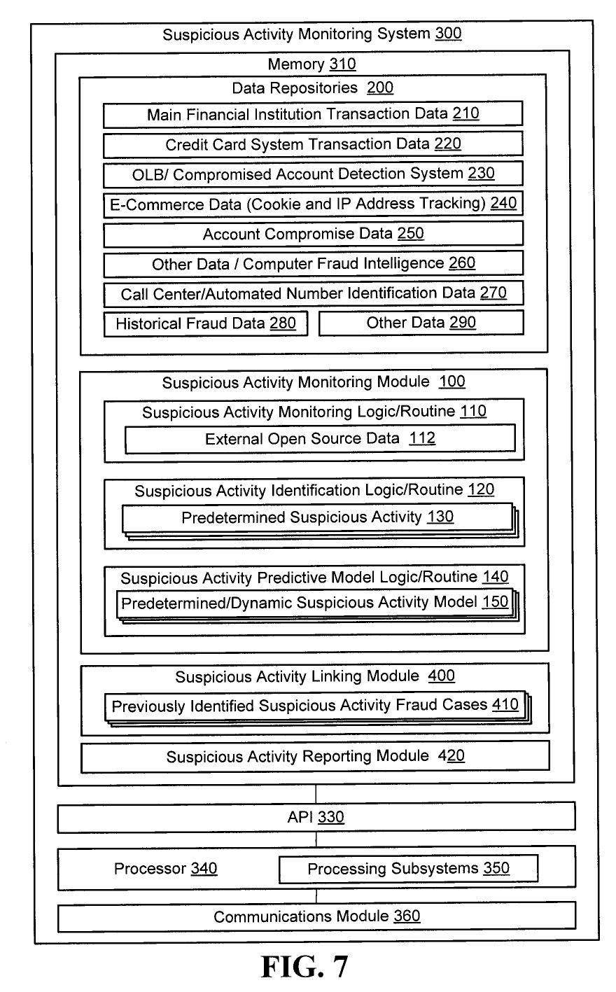

FIG. 7 provides a more detailed block diagram of a system 10 for suspicious activity monitoring, in accordance with another embodiment of the invention. In addition to providing greater detail than FIG. 6, FIG. 7 highlights various alternate embodiments. The system 10 may include one or more of any type of computerized device. The present apparatus and methods can accordingly be performed on any form of computing device.

The system includes memory 20, which may comprise volatile and non-volatile memory, such as read-only and/or random-access memory (RAM and ROM), EPROM, EEPROM, flash cards, or any memory common to computer platforms. Further, memory 20 may include one or more flash memory cells, or may be any secondary or tertiary storage device, such as magnetic media, optical media, tape, or soft or hard disk.

Further, system 10 also includes processor 30, which may be an application-specific integrated circuit (“ASIC”), or other chipset, processor, logic circuit, or other data processing device. Processor 30 or other processor such as ASIC may execute an application programming interface (“API”) 40 that interfaces with any resident programs, such as the suspicious activity monitoring module 100 and related applications/routines and/or logic or the like stored in the memory 20 of the system 10.

Processor 30 includes various processing subsystems 50 embodied in hardware, firmware, software, and combinations thereof, that enable the functionality of system 10 and the operability of the system on a network. For example, processing subsystems 50 allow for initiating and maintaining communications and exchanging data with other networked devices. For the disclosed aspects, processing subsystems 50 of processor 30 may include any subsystem used in conjunction with the suspicious activity monitoring module 100 or the like or subcomponents or sub-modules thereof

System 10 additionally includes communications module 60 embodied in hardware, firmware, software, and combinations thereof, that enables communications among the various components of the system 10, as well as between the other devices in the network. Thus, communication module 60 may include the requisite hardware, firmware, software and/or combinations thereof for establishing a network communication connection.

The memory 20 includes suspicious activity monitoring module 100 that is executable by processor 30. The suspicious activity monitoring module receives data from data repositories 200. As previously discussed, data repositories 200 may include, but are not limited to, main financial institution transaction data 210, credit card system transaction data 220, online banking/compromised account detection system data 230, ecommerce data 240, compromised account data 250, computer fraud intelligence data 260, call center/automated number identification data 270, historical fraud data 280 and any other data 290 that may relevant to the ability to identify suspicious activity.

The suspicious activity monitoring module 100 includes suspicious activity monitoring logic/routine 110. The suspicious activity monitoring logic/routine 110 is configured to receive the data from the plurality of data repositories 200 and format and correlate the data for the purpose of analysis by a designated user/analyst. In addition, external open source data 112, such as declassified information, public media outlet data or the like will serve as an input to the suspicious activity monitoring logic/routine 110, which will filter/search the data received from the data repositories to identify data associated with suspicious activity.

In alternative embodiments of system 10, the suspicious activity monitoring module 100 may also include suspicious activity identification logic/routine 120 which provides for automated or user configured monitoring of one or more of a plurality of predetermined suspicious activities 130. The predetermined suspicious activities are generally those activities which may be associated with other known business activities such that identification of the suspicious activity may lead to automated monitoring of other data in the monitoring module 100. Thus, identification of a predetermined suspicious activity 130 may trigger, automated or manual initiation, of monitoring other data or inputting further data as an input to the monitoring process.

In another alternative embodiment of system 10, the suspicious activity monitoring module 100 may also include suspicious active predictive model logic/routine 140 that includes a plurality of predetermined and/or dynamic suspicious activity models 150. The predetermined and/or dynamic suspicious activity models 150 may comprise a combination of business activities that in the aggregate rise to a suspicious activity or predict the likelihood of an eventual suspicious activity or a pattern of business activities that in succession give rise to a suspicious activity or predict the likelihood of an eventual suspicious activity. The models may be predefined based on historical data or dynamically defined based on current business activity and/or suspicious activity. Additionally, the suspicious active predictive model logic/routine 140 may implement algorithmic and/or heuristic analysis to make intuitive judgments as to future predictive suspicious activity. Based on the identification of a predetermined and/or dynamic suspicious activity model 150 further monitoring, automated or at the bequest of an analyst, may ensue with the data surrounding the suspicious activity model serving as the input for further monitoring.

Additionally, suspicious activity monitoring system 10 may include suspicious activity linking module 400 that provides for linking identified suspicious activities to previously identified, closed or open, suspicious activity fraud cases 410. Also, the suspicious activity monitoring system 10 may include suspicious activity reporting module 420 operable for generating and initiating communication of suspicious activity reports to internal and/or external requesters.

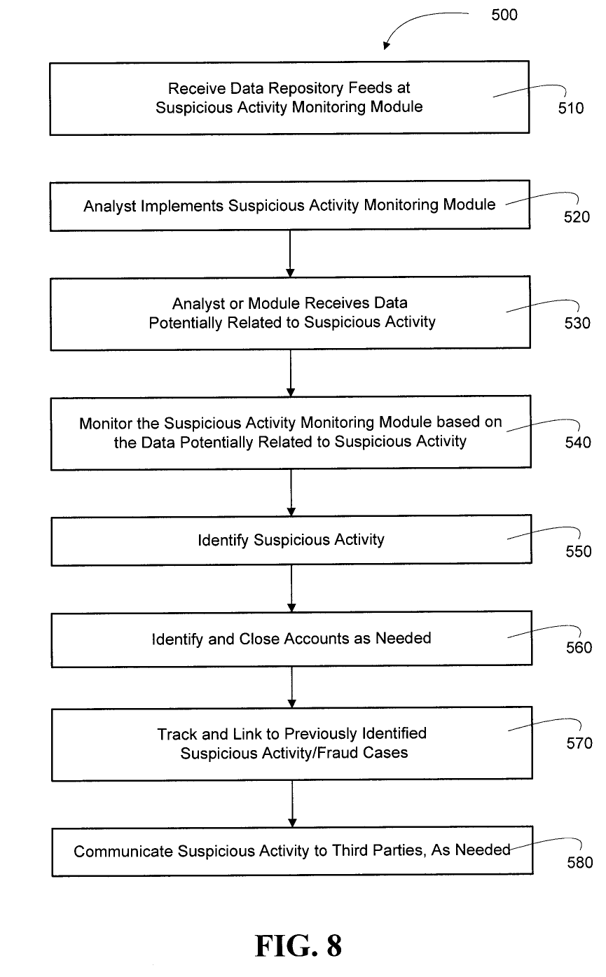

FIG. 8 a flow diagram of a method 500 for monitoring suspicious activity in a financial institution enterprise, in accordance with an embodiment of the present invention. At Event 510, the suspicious activity monitoring module receives data feeds from a plurality of data repositories/databases associated with or otherwise accessible to the financial institution. The data repositories/databases may include, but are not limited to, the main financial institution transaction database, credit card system(s) transaction databases, online banking transaction database, compromised account detection system, electronic-commerce database, data related to known or suspect computer security violators (i.e., hackers), counter fraud intelligence data, such as viruses, trojans or malware targeting financial institution customers, historical financial institution fraud data and/or call center/automated number identification data. The data from the data repositories may be downloaded periodically or a predetermined scheduled or on an as-needed basis or the module may be configured to receive real-time feeds of the data from the data repositories.

At Event 520, a user/analyst implements or otherwise logs on to a suspicious activity monitoring module. At Event 530, the user/analyst receives data potentially related to suspicious activity. The data potentially related to suspicious activity serves as the inputs to the suspicious activity monitoring module. The data may be received or otherwise obtained from any public source, such as the Internet, press releases, media alerts or the like, or from declassified documents. In many instances the data will include a name of an individual or names of individuals; however, in other instances the data may be limited to one or more of a physical address, an electronic address, such as an email address or an IP address, a telephone number or the like.

At Event 540, the user/analysts monitors the data in the suspicious activity monitoring module based on the inputted data potentially related to suspicious activity. Monitoring may include filtering and/or searching the data to determine if the data is associated with a financial institution customer and, if so, identification of accounts related to the customer. In addition, monitoring may include searching the transactional data associated with the identified customer to identify suspicious debits, deposits or the like, such as debit card purchases, wire transfers, cash deposits, third party checks, Automated Teller Machine (ATM) deposits, cashier's checks and the like. In other instances in which the data potentially related to suspicious activity was previously inputted and saved to the suspicious activity monitoring module, user/analyst log on may prompt a report to be executed that details any suspicious activity associated with the data (i.e., name, address or the like). In this regard, the monitoring is automated based on the previously inputted data.

At Event 550, suspicious activity is identified by the user/analyst. In accordance with embodiments of the invention, the user/analyst may manually identify suspicious activity based a review of data items in the module or based on a specific search/filter the suspicious activity monitor module may automatically identify suspicious activity, which is then confirmed by the user/analyst. In addition, in those embodiments implementing reporting functionality, the queried report may identify the suspicious activity. The suspicious activity may include, but is not limited, to suspicious transactions, including deposits, withdrawals, wire transfers, and the like, suspicious IP addresses, suspicious telephone numbers, suspicious accounts, previously frauds, suspicious external activity, such as being associated with computer security violations, fraudulent telephone calls, fraudulent or nefarious computer software or the like.

At Event 560, once suspicious activity is identified, actions are taken to prevent any further suspicious activity. These actions may include suspending or otherwise closing accounts related to the suspect activity, notifying affected parties and the like. At Event 560, the suspicious activity prompts further tracking of activities associated with the identified suspicious activity, such as further tracking of the customer(s)/individual(s) associated with the suspicious activity. Additionally, the suspicious activity is checked against the known database of previous suspicious activity/fraud cases to determine if a link exists between the suspicious activity and previous activity/fraud cases.

At Event 570, based on identification of the suspicious activity, third parties are notified of the activity, as needed. Third party notification may include but is not limited to, law enforcement agency, investigation services agency and the like.

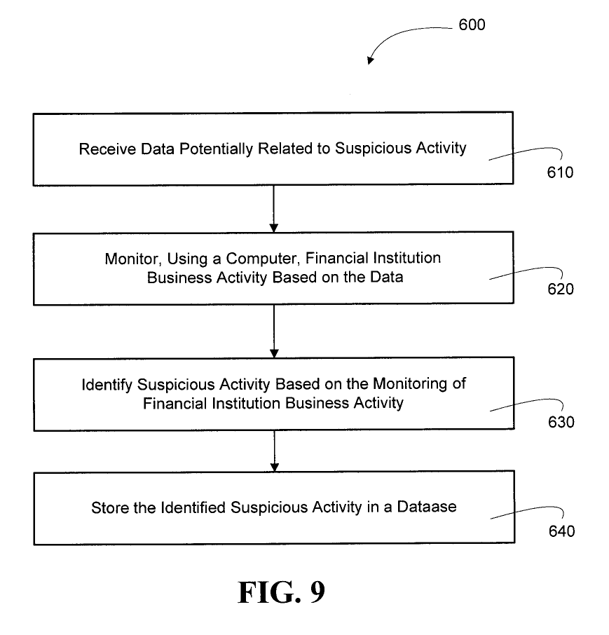

Turning the reader's attention to FIG. 9 another flow diagram is provided of a method 600 for monitoring suspicious activity at a financial institution enterprise, in accordance with another embodiment of the invention. At Event 610, data potentially related to a suspicious activity is received. As previously noted, the data serves as the inputs to a suspicious activity monitoring module. The data may be received or otherwise obtained from any public source, such as the Internet, press releases, media alerts or the like, or from declassified documents. In many instances the data will include a name of an individual or names of individuals; however, in other instances the data may be limited to one or more of a physical address, an electronic address, such as an email address or an IP address, a telephone number or the like. The data may be manually received by a user/analyst and manually inputted into the suspicious activity monitoring module or, in other embodiments; the data may be automatically received into the suspicious activity monitoring module from a related data generating source.

At Event 620, financial institution business activity and/or activity ancillary to financial institution business is monitored by a computer and, specifically according to embodiments herein discussed, a suspicious activity monitoring module. Business activity includes main financial institution transaction activity, credit card transaction activity, online banking activity, call center activity, e-commerce activity, previously identified fraudulent activity and the like. Activity ancillary to the financial business includes compromised account detection systems, computer security violators' data, counter fraud intelligence data, such known computer programs/viruses targeting financial institution customers, fraudulent telephone numbers and the like. As previously discussed, monitoring may include receiving data from a plurality of data repositories associated with the financial institution or other data repositories having data relevant to suspicious activity. In such embodiments, the suspicious activity monitoring module receives the data and formats/correlates the data to provide for the data to be searched, filtered and/or analyzed by a user/analyst. In other embodiments, the suspicious activity monitoring module may be in communication with the plurality of data repositories/databases such that monitoring occurs remotely at the data repository/database location, without the need to communicate the data to the suspicious activity monitoring module.

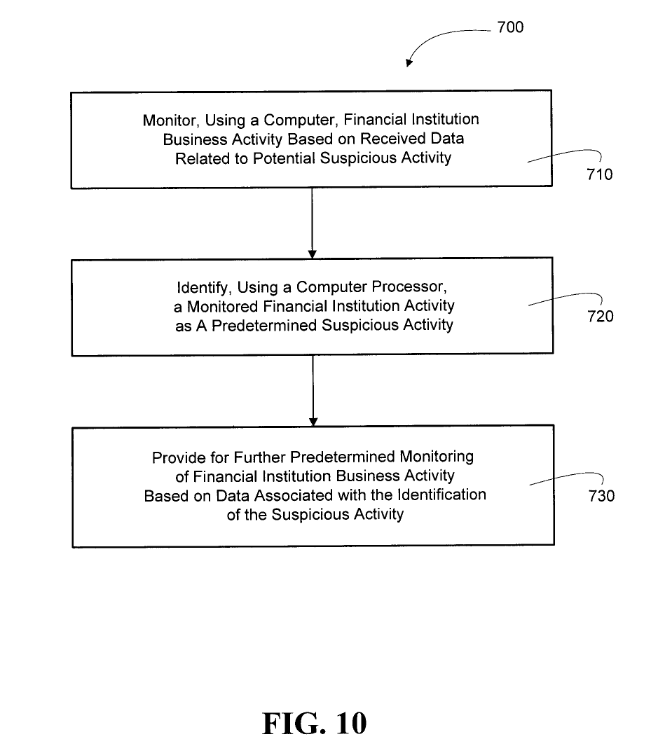

At Event 630, suspicious activity is identified based on the monitoring of financial institution business activity or activity ancillary to financial institution activity. As noted, the suspicious activity may include, but is not limited to, suspicious transactions, including deposits, withdrawals, wire transfers, and the like, suspicious IP addresses, suspicious telephone numbers, suspicious accounts, previously frauds, suspicious external activity, such as being associated with computer security violations, fraudulent telephone calls, fraudulent or nefarious computer software or the like. At Event 640 the suspicious activity is associated with a customer/individual or the like and stored in a database. In addition, not shown in FIG. 10, the suspicious activity may be further tracked to identify further ongoing suspicious activity or activities and/or the suspicious activity and related information may be communicated to a third party of interest, such as a law enforcement agent, investigation agency or the like.

Referring to FIG. 10, another flow diagram is presented of an alternate method 700 for monitoring suspicious activity at a financial institution enterprise, in accordance with another embodiment of the invention. At Event 710, computerized monitoring of financial institution business activity and other activity ancillary to the financial institution activity occurs based on received data related to potential suspicious activity. As previously noted, monitoring may occur on data received from a plurality of data repositories/databases or the monitoring may occur remotely by communicating with the plurality of data repositories/databases.

At Event 720, a monitored financial institution business activity is identified as a predetermined suspicious activity. The identification of the suspicious activity may occur manually by a user/analyst or the identification may be an automated identification of the suspicious activity based on tracking financial institution business activity or in response to a specified query for a suspicious activity. The suspicious activity is a predetermined suspicious activity, meaning the financial institution or some other entity has configured the system such that the predetermined suspicious activity triggers further monitoring.

At Event 730, based on data associated with the identification of the predetermined suspicious activity, further predetermined monitoring of the financial institution business activity is provided. In most instances, identification of the predetermined suspicious activity automatically prompts the monitoring of further financial institution business activity. For example, if monitoring identifies a suspicious activity, such as suspicious telephone calls to one or more call centers, and this suspicious activity is a predetermined suspicious activity, further predetermined monitoring may occur. The further predetermined monitoring may be based on the telephone number or numbers used in the suspicious telephone call to the call centers. The method may automatically monitors/searches and/or filters other predetermined financial institution business activities, such as account transaction databases or the like to determine if other suspicious activities are associated with the telephone number or other business activities related to the telephone number.

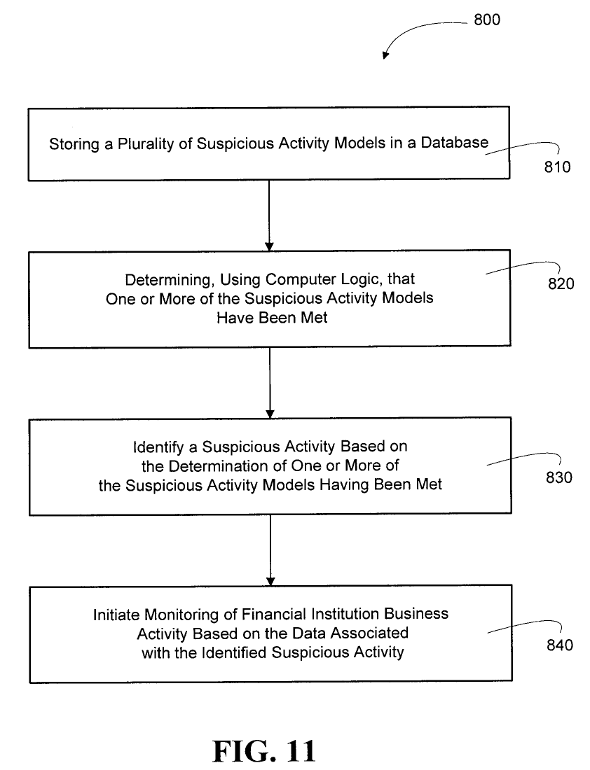

FIG. 11 provides for another method 800 of monitoring for suspicious activities at a financial institution enterprise, according to yet another embodiment of the invention. At Event 810, a plurality of suspicious activity models are stored in a database. The suspicious activity models may define a pattern of business activities or a combination of business activities, which if monitored and identified on their own may not result in the identification of suspicious activity. Thus, the suspicious activity models may have thresholds, such as dollar amount thresholds or proximate in time thresholds, associated with the business activities in order to define whether the business activities should be included within a pattern of business activities or a combination of business activities. In addition, the suspicious activity models may be predefined or dynamically determined based on monitoring results.

At Event 820, a determination is made that one or more of the suspicious activity models have been met. In other words, a predefined pattern of business activities and/or a combination of business activities has been determined to have occurred. This determination may occur manually by a user/analyst observing or otherwise monitoring financial institution business activity or it may occur automatically by implementation of an appropriate software application/routine. At Event 830, a suspicious activity is identified based on the determination of one or more suspicious activity models having been met. In certain embodiments, the suspicious activity model is associated with one or more predetermined suspicious activities, such that determination that a model has been met automatically identifies one or more suspicious activities.

At optional Event 840, based on the identification of the suspicious activity, further monitoring of financial institution business activity may manually or automatically occur based on data associated with the identified suspicious activity. Hence, if the identified suspicious activity includes an IP address of a computer associated with the suspicious activity, further searching, filtering and/or monitoring of other data may be warranted to determine if further suspicious activities are associated with the IP address.

Thus, as described herein, present embodiments provide for methods, systems, and computer program products that provide for r monitoring of financial institution business activity for the purpose of identifying suspicious activities. The embodiments herein described rely on monitoring business activities from many data repositories, some of which are exclusive to financial institution. In specific embodiments of the invention, identification of a suspicious activity may automatically trigger further monitoring in attempt to uncover further suspicious activities or events. In other embodiments, predictive modeling may used to identify predetermined suspicious activity patterns or predetermined combinations of suspicious activity that may otherwise go unnoticed. Thus, the embodiments herein described provide for heightened identification of suspicious activities.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for investigating a suspicious entity associated with a business, the method comprising:
receiving data associated with a suspicious individual;
verifying, via a computing device processor, that the suspicious entity is associated with the business based on the data;
identifying, via a computing device processor, a plurality of business-related identifying characteristics associated with the suspicious individual; and
determining, via a computing device processor, one or more related entities associated with the suspicious entity based on at least one link between each of the related entities and the identifying characteristics associated with the suspicious entity.

2. The method of claim 1, wherein receiving data further comprises receiving one or more of a name, a physical address, a telephone number, an electronic mail address, or an Internet Protocol address.

3. The method of claim 1, wherein verifying further comprises verifying, via the computing device processor, that the suspicious entity is a customer of the business based on a match between the data and a customer profile.

4. The method of claim 1, wherein identifying further comprises identifying, via a computing device processor, the plurality of business-related identifying characteristics, wherein the identifying characteristics include a physical address stored in customer profile associated with the suspicious individual.

5. The method of claim 4, wherein determining further comprises determining, via a computing device processor, the one or more related entities associated with the suspicious entity based on at least one link, wherein the links include the related entities being associated with the physical address of the suspicious individual.

6. The method of claim 1, wherein identifying further comprises identifying, via a computing device processor, the plurality of business-related identifying characteristics, wherein the identifying characteristics include one or more accounts associated with the suspicious entity held at the business.

7. The method of claim 6, wherein determining further comprises determining, via a computing device processor, the one or more related entities associated with the suspicious entity based on at least one link, wherein the links include the related entities being associated with at least one of the accounts associated with the suspicious individual.

8. The method of claim 1, wherein identifying further comprises identifying, via a computing device processor, the plurality of business-related identifying characteristics including wherein business encounter-related identifying characteristics.

9. The method of claim 8, wherein identifying further comprises identifying, via a computing device processor, the plurality of business encounter-related identifying characteristics, wherein the business encounter-related identifying characteristics are based on the business encounter requiring user authentication.

10. The method of claim 8, wherein identifying further comprises identifying, via a computing device processor, the plurality of business encounter-related identifying characteristics, wherein the identifying characteristics include one or more telephone numbers from which the suspicious entity contacted a business call center.

11. The method of claim 10, wherein determining further comprises determining, via a computing device processor, the one or more related entities associated with the suspicious entity based on at least one link, wherein the links include the related entities having contacted the business call center from one of the telephone numbers.

12. The method of claim 8, wherein identifying further comprises identifying, via a computing device processor, the plurality of business encounter-related identifying characteristics, wherein the identifying characteristics include one or more Internet Protocol (IP) addresses associated with suspicious entity and used for computer network communication between the suspicious entity and the business.

13. The method of claim 12, determining further comprises determining, via a computing device processor, the one or more related entities associated with the suspicious entity based on at least one link, wherein the links include the related entities having used one of the IP addresses for computer network communication with the business.

14. The method of claim 8, wherein identifying further comprises identifying the plurality of business encounter-related identifying characteristics, wherein the identifying characteristics include one or more identifying text files associated with a computing device that was used for computer network communication between the suspicious entity and the business.

15. The method of claim 14, wherein determining, further comprises determining, via a computing device processor, the one or more related entities associated with the suspicious entity based on at least one link, wherein the links include the related entities being associated with one of the identifying text files and having used the computing device for computer network communication with the business.

16. The method of claim 1, wherein receiving data associated with a suspicious entity further comprises monitoring, via a computing device processor, business activity based on predetermined suspicious activity criteria to determine the data.

17. An apparatus for investigating a suspicious entity associated with a business, the method comprising:
a computing platform including a memory and processor in communication with the memory;
a suspicious entity identifying characteristic routine stored in the memory, executable by the processor and configured to identify a plurality of business-related identifying characteristics associated with a suspicious entity associated with the business; and
a related suspicious entity determining routine stored in the memory, executable by the processor and configured to determine one or more related entities associated with the suspicious entity based on at least one link between each of the related entities and the identifying characteristics associated with the suspicious individual.

18. The apparatus of claim 17, further comprising a suspicious entity verification routine stored in the memory, executable by the processor and configured to receive data associated with a suspicious entity and verify that the suspicious entity is associated with the business based on the data;

19. The apparatus of claim 18, wherein the suspicious entity verification routine is further configured to receive one or more of a name, a physical address, a telephone number, an electronic mail address, or an Internet Protocol address.

20. The apparatus of claim 18, wherein the suspicious entity verification routine is further configured to verify that the suspicious entity is a customer of the business based on a match between the data and a customer profile.

21. The apparatus of claim 17, wherein the suspicious entity identifying characteristic routine is further configured to identify the plurality of business-related identifying characteristics, wherein the identifying characteristics include a physical address stored in customer profile associated with the suspicious individual.

22. The apparatus of claim 21, wherein the related suspicious entity determining routine is further configured to determine the one or more related entities associated with the suspicious entity based on at least one link, wherein the links include the related entities being associated with the physical address of the suspicious individual.

23. The apparatus of claim 17, wherein the suspicious entity identifying characteristic routine is further configured to identify the plurality of business-related identifying characteristics, wherein the identifying characteristics include one or more accounts associated with the suspicious entity held at the business.

24. The apparatus of claim 23, wherein the related suspicious entity determining routine is further configured to determine the one or more related entities associated with the suspicious entity based on at least one link, wherein the links include the related entities being associated with at least one of the accounts associated with the suspicious individual.

25. The apparatus of claim 17, wherein the suspicious entity identifying characteristic routine is further configured to identify the plurality of business-related identifying characteristics, wherein the identifying characteristics include business encounter-related identifying characteristics.

26. The apparatus of claim 25, wherein the suspicious entity identifying characteristic routine is further configured to identify the plurality of business encounter-related identifying characteristics, wherein the business encounter-related identifying characteristics are based on the business encounter requiring user authentication.

27. The apparatus of claim 25, wherein the suspicious entity identifying characteristic routine is further configured to identify the plurality of business encounter-related identifying characteristics, wherein the identifying characteristics include one or more telephone numbers from which the suspicious entity contacted a business call center.

28. The apparatus of claim 27, wherein the related suspicious entity determining routine is further configured to determine the one or more related entities associated with the suspicious entity based on at least one link, wherein the links include the related entities having contacted the business call center from one of the telephone numbers.

29. The apparatus of claim 25, wherein the suspicious entity identifying characteristic routine is further configured to identify the plurality of business encounter-related identifying characteristics, wherein the identifying characteristics include one or more Internet Protocol (IP) addresses associated with suspicious entity and used for computer network communication between the suspicious entity and the business.

30. The apparatus of claim 29, wherein the related suspicious entity determining routine is further configured to determine the one or more related entities associated with the suspicious entity based on at least one link, wherein the links include the related entities having used one of the IP addresses for computer network communication with the business.

31. The apparatus of claim 25, wherein suspicious entity identifying characteristic routine is further configured to identify the plurality of business encounter-related identifying characteristics, wherein the identifying characteristics include one or more identifying text files associated with a computing device that was used for computer network communication between the suspicious entity and the business.

32. The apparatus of claim 31, wherein the related suspicious entity determining routine is further configured to determine the one or more related entities associated with the suspicious entity based on at least one link, wherein the links include the related entities being associated with one of the identifying text files and having used the computing device for computer network communication with the business.

33. The apparatus of claim 17, further comprising a suspicious activity monitoring routine configured to monitor business activity based on predetermined suspicious activity criteria to determine the data.

34. A computer program product comprising:
a computer-readable medium comprising:
a first set of codes for causing a computer to receive data associated with a suspicious individual;
a second set of codes for causing a computer to verify that the suspicious entity is associated with the business based on the data;
a third set of codes for causing a computer to identify a plurality of business-related identifying characteristics associated with the suspicious individual; and
a fourth set of codes for causing a computer to determine one or more related entities associated with the suspicious entity based on at least one link between each of the related entities and the identifying characteristics associated with the suspicious individual.

35. The computer program product of claim 34, wherein the first set of codes is further configured to cause the computer to receive one or more of a name, a physical address, a telephone number, an electronic mail address, or an Internet Protocol address.

36. The computer program product of claim 34, wherein the second set of codes is further configured to cause the computer to verify that the suspicious entity is a customer of the business based on a match between the data and a customer profile.

37. The computer program product of claim 34, wherein the third set of codes is further configured to cause the computer to identify the plurality of business-related identifying characteristics, wherein the identifying characteristics include a physical address stored in customer profile associated with the suspicious individual.

38. The computer program product of claim 37, wherein the fourth set of codes is further configured to cause the computer to determine the one or more related entities associated with the suspicious entity based on at least one link, wherein the links include the related entities being associated with the physical address of the suspicious individual.

39. The computer program product of claim 34, wherein the third set of codes is further configured to cause the computer to identify the plurality of business-related identifying characteristics, wherein the identifying characteristics include one or more accounts associated with the suspicious entity held at the business.

40. The computer program product of claim 39, wherein the fourth set of codes is further configured to cause the computer to determine the one or more related entities associated with the suspicious entity based on at least one link, wherein the links include the related entities being associated with at least one of the accounts associated with the suspicious individual.

41. The computer program product of claim 34, wherein the third set of codes is further configured to cause the computer to identify the plurality of business-related identifying characteristics including wherein business encounter-related identifying characteristics.

42. The computer program product of claim 41, wherein the third set of codes is further configured to cause the computer to identify the plurality of business encounter-related identifying characteristics, wherein the business encounter-related identifying characteristics are based on the business encounter requiring user authentication.

43. The computer program product of claim 41, wherein the third set of codes is further configured to cause the computer to identify the plurality of business encounter-related identifying characteristics, wherein the identifying characteristics include one or more telephone numbers from which the suspicious entity contacted a business call center.

44. The computer program product of claim 43, wherein the fourth set of codes is further configured to cause the computer to determine the one or more related entities associated with the suspicious entity based on at least one link, wherein the links include the related entities having contacted the business call center from one of the telephone numbers.

45. The computer program product of claim 41, wherein the third set of codes is further configured to cause the computer to identify the plurality of business encounter-related identifying characteristics, wherein the identifying characteristics include one or more Internet Protocol (IP) addresses associated with suspicious entity and used for computer network communication between the suspicious entity and the business.

46. The computer program product of claim 45, wherein the fourth set of codes is further configured to cause the computer to determine the one or more related entities associated with the suspicious entity based on at least one link, wherein the links include the related entities having used one of the IP addresses for computer network communication with the business.

47. The computer program product of claim 41, wherein the third set of codes is further configured to cause the computer to identify the plurality of business encounter-related identifying characteristics, wherein the identifying characteristics include one or more identifying text files associated with a computing device that was used for computer network communication between the suspicious entity and the business.

48. The computer program product of claim 47, wherein the fourth set of codes is further configured to cause the computer to determine the one or more related entities associated with the suspicious entity based on at least one link, wherein the links include the related entities being associated with one of the identifying text files and having used the computing device for computer network communication with the business.

49. The computer program product of claim 34, further comprising a fifth set of codes for causing a computer to monitor business activity based on predetermined suspicious activity criteria to determine the data.
